(19) United States
(12) Patent Application Publication
(10) Pub. No.: US 2009/0274241 A1
(43) Pub. Date: Nov. 5, 2009

(54) Data Transmission Device and Related Method

(76) Inventors: Wen-Yuan Tsao, Hsinchu County (TW); Che-Li Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/175,463

(22) Filed: Jul. 18, 2008

(30) Foreign Application Priority Data
Apr. 30, 2008 (TW) 097115919

(51) Int. Cl. H04L 27/00

(52) U.S. Cl. 375/295

(57) ABSTRACT

In order to resolve problems of clock and data skews in transmission signals in a display device, the present invention provides a data transmission device including a timing controller, a plurality of source drivers and a plurality of transmission line sets. The timing controller generates a plurality of definable signals each generating at least four voltage levels. The plurality of source drivers receives the plurality of definable signals. The plurality of transmission line sets are coupled between the timing controller and the plurality of source drivers and used for transmitting the plurality of definable signals. Preferably, the plurality of definable signals are differential signals.

### BACKGROUND OF THE INVENTION

1. Field of the Invention

The present invention relates to a data transmission device and related method, and more particularly to a data transmission device and related method for avoiding sampling errors caused by clock and data skews in a display device.

2. Description of the Prior Art

Featuring low radiation, thin appearance and low power consumption, liquid crystal display (LCD) devices have gradually replaced traditional cathode ray tube (CRT) displays and been widely used in notebook computers, personal digital assistants (PDA), flat panel televisions or mobile phones. The LCDs have gradually replaced traditional cathode ray tube (CRT) displays and became a display market trend. An active matrix TFT LCD, the most popular type of LCDs, includes a driving system generally consisting of a timing controller, source drivers, and gate drivers.

The source drivers and the gate drivers are responsible for signal outputs of data lines and scan lines, intersecting to form a cell matrix, respectively. Each intersection is a cell including crystal display molecules and a TFT. In the driving system, the gate drivers transmit scan signals to gates of TFTs to turn on the TFTs on the panel. The source drivers convert digital image data, sent by the timing controller, into analog voltage signals and then output the voltage signals to sources of the TFTs. When a TFT receives corresponding voltage signal, the associated liquid crystal molecule has a terminal whose voltage becomes equal to the drain voltage of the TFT, and thereby changes its own twist angle, causing a change of a light penetrating rate of the liquid crystal molecule. Thus, different colors can be displayed on the panel. The timing controller mostly uses differential signaling (DS) interfaces to transfer data to the source drivers. Common DS interfaces are reduced swing differential signaling (RSDS) and mini low voltage differential signaling (mini-LVDS) interfaces.

Please refer to FIG. 1, which illustrates a schematic diagram of a LCD 10 adopting the RSDS interface according to the prior art. The LCD 10 includes a timing controller 100 and source drivers CD1-CD8. The timing controller 100 generates two sets of data, clock and control signals, and the sets are transmitted to the source drivers CD1-CD4 and CD5-CD8 in a bus manner, respectively. The data signals for the source drivers CD1-CD4 are RSDS signals R1_Pj/Nj, G1_Pj/Nj and B1_Pj/Nj, which represent RGB (Red, Green, Blue) data of 6-bit color depth respectively, where j=1-3. The source drivers CD1-CD4 receive data from the timing controller 100 according to the rising and falling edges of the clock signal CLK1_P1/N1 as well as an RSDS signal. An output setup signal STB1, one of the control signals, controls the time the source drivers CD1-CD4 output signals. A polarity signal POL1, another control signal, controls polarity of the output signals of the source drivers CD1-CD4. Signal usage for the source drivers CD5-CD8 are the same as that for the source drivers CD1-CD4. Furthermore, the timing controller 100 generates receiving setup signals DIO1 and DIO2, indicating the source drivers CD4 and CD5 to prepare for data reception. The receiving setup signal DIO1 is sequentially transmitted from the source driver CD4 to the source drivers CD3-CD1 in a cascading manner, and receiving setup signals DIO43, DIO32 and DIO21 are delay versions of the receiving setup signal DIO1. The receiving setup signal DIO2 is sequentially transmitted from the source driver CD5 to the source driver CD6-CD8 in a cascading manner, and receiving setup signals DIO56, DIO67 and DIO78 are delay versions of the receiving setup signal DIO2.

As the LCDs moves toward a large panel size, a high resolution and a high frame rate, the data transmission rate in the driving system is substantially increased. Besides, in the LCD 10 of the prior art, transmission of data and clock signals employs the bus transmission interface. As a result, severe data and clock skews can occur in transmission signals, causing difficulty or errors in sampling for the source driver.

Please refer to FIG. 2, which illustrates a waveform diagram of data signal pairs accompanied with inter-source-driver skews in the LCD 10 of the prior art. A data signal pair CD4_R1_P1/N1 represents the RSDS signal R1_P1/N1 received by the source driver CD4, whereas a data signal pair CD1_R1_P1/N1 represents the RSDS signal R1_P1/N1 received by the source driver CD1. In FIG. 2, an eye width of the data signal pair CD4_R1_P1/N1 is Tp1 as well as a valid sampling duration provided by the clock signal CLK1_P1/N1. As known from the above, the source drivers CD1-CD4 jointly receives the RSDS signal R1_P1/N1 via a bus. Therefore, the data signal pair CD1_R1_P1/N1 is delayed to be received source driver by source driver due to different transmission line lengths. Assuming the delay time is T11, an overlapping duration of the data signal pairs CD4_R1_P1/N1 and CD1_R1_P1/N1 is T21 as well as a true valid sampling duration for the source drivers CD1-CD4. Thus, the valid sampling duration is decreased from Tp1 to T21.

As the data transmission rate increases, the durations Tp1 and T21 are further reduced. In addition, as a circuit board of the driving system is lengthened, the duration T11 is increased whereas the duration T21 is decreased. These cause an insufficient eye width and an inadequate valid sampling duration in the source drivers.

Please refer to FIG. 3, which illustrates a waveform diagram of data signal pairs accompanied with intra-source-driver skews in the LCD 10 of the prior art. The data signal pairs CD1_R1_P1/N1 and CD1_R1_P3/N3 represent the RSDS signals R_P1/N1 and R1_P3/N3 received by the source driver CD1 respectively. In FIG. 3, the data signal pair CD1_R1_P1/N1 has an eye width of Tp2 as well as a valid sampling duration provided by the clock signal CLK1_P1/N1. However, the data signal pairs CD1_R1_P1/N1 and CD1_R1_P3/N3 have time difference in receiving time due to different transmission line lengths. Assuming the time difference is T12, an overlapping duration of the data signal pairs CD1_R1_P3/N3 and CD1_R1_P1/N1 is T22 as well as a true valid sampling duration for the source driver CD1. Thus, the valid sampling duration is decreased from Tp2 to T22.

As the data transmission rate increases, the durations Tp2 and T22 are further reduced, also causing decrease in the eye width and the valid sampling duration in the source drivers.

Please refer to FIG. 4, which illustrates a schematic diagram of a clock skew occurred in the LCD 10 of the prior art. In FIG. 4, data durations DW13 and DW23 are durations for the source driver CD4 to receive data correctly. The data durations DW33 and DW43 are durations for the source driver CD1 to receive data correctly. The clock signal CD1_CLK1_P1/N1 and CD4_CLK1_P1/N1 represent the clock signal CLK1_P1/N1 received by the source drivers CD1 and CD4 respectively. The time points P1 and P2 are time points for the source drivers CD1 and CD4 to start to receive and latch data, respectively. To ensure the source driver CD4 accurately receives the data durations DW13 and DW23, it is necessary that the time point P1 falls within a duration T23. To ensure the source driver CD1 accurately receives the data durations DW33 and DW43, it is necessary that the time point P2 falls within a duration T33. However, a phase difference Td between the clock signals CD1_CLK1_P1/N1 and CD4_CLK1_P1/N1 results from the bus transmission for the clock signal CLK1_P1/N1. A large or small phase difference Td can cause the time point P2 to fall outside the duration T33, resulting sampling errors in the source driver CD1.

### SUMMARY OF THE INVENTION

The present invention provides a data transmission device and related method, controlling data transmission timing with cascading, bus, and dedicated channel transmission to mitigate data and clock skews.

The present invention discloses a data transmission device including a timing controller, a plurality of source drivers and a plurality of transmission line sets. The timing controller generates a plurality of definable signals each generating at least four voltage levels. The plurality of source drivers receives the plurality of definable signals. The plurality of transmission line sets are coupled between the timing controller and the plurality of source drivers and used for transmitting the plurality of definable signals.

The present invention further discloses a data transmission method for a display device including generating a plurality of definable signals each generating at least four voltage levels, and then transmitting the plurality of definable signals via a plurality of transmission line sets.

The present invention further discloses a data transmission device for a display device including a timing controller, a plurality of source drivers and a plurality of transmission line sets. The timing controller is used for generating a plurality of differential signals each generating at least four voltage levels. The plurality of source drivers is used for receiving the plurality of differential signals. The plurality of transmission line sets are coupled between the timing controller and the plurality of source drivers in a dedicated channel manner, and used for transmitting the plurality of differential signals.

The present invention further discloses a data transmission method for a display device comprising a timing controller and a plurality of source drivers. The data transmission method includes generating a plurality of differential signals each generating at least four voltage levels, and then transmitting the plurality of differential signals between the timing controller and the plurality of source drivers via a plurality of transmission line sets in a dedicated channel manner.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a LCD according to the prior art.

FIG. 2 illustrates a waveform diagram of data signal pairs accompanied with inter-source-driver skews in the LCD according to in FIG. 1.

FIG. 3 illustrates a waveform diagram of data signal pairs accompanied with intra-source-driver skews in the LCD 10 according to FIG. 1.

FIG. 4 illustrates a schematic diagram of a clock skew occurred in the LCD according to in FIG. 1.

FIG. 5 illustrates a schematic diagram of a data transmission device of a display device according to an embodiment of the present invention.

FIGS. 6 to 12 illustrate schematic diagrams of data transmission device of a display device according to an embodiment of the present invention.

FIG. 13 illustrates a flowchart of a data transmission process according to an embodiment of the present invention.

FIG. 14 illustrates a waveform schematic diagram of the data signal pairs of the data transmission device according to FIG. 5.

FIG. 15 illustrates a waveform schematic diagram of the data signal pairs of the data transmission device according to FIG. 6.

FIG. 16 illustrates a schematic diagram of a data transmission device employing four voltage levels according to an embodiment of the present invention.

FIG. 17 illustrates a schematic diagram of a data transmission device employing six voltage levels according to an embodiment of the present invention.

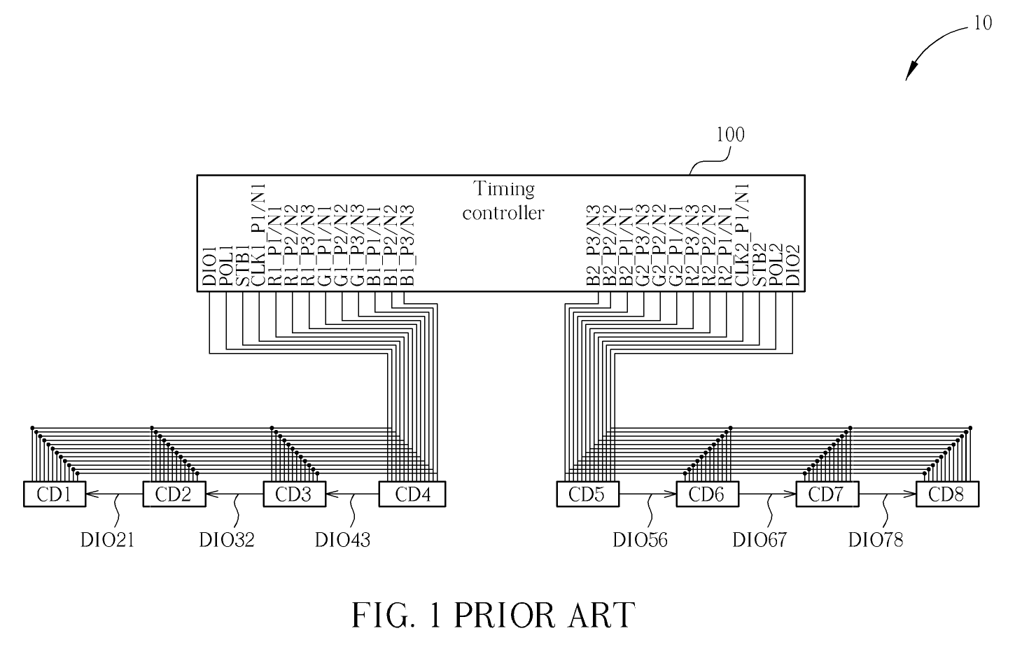

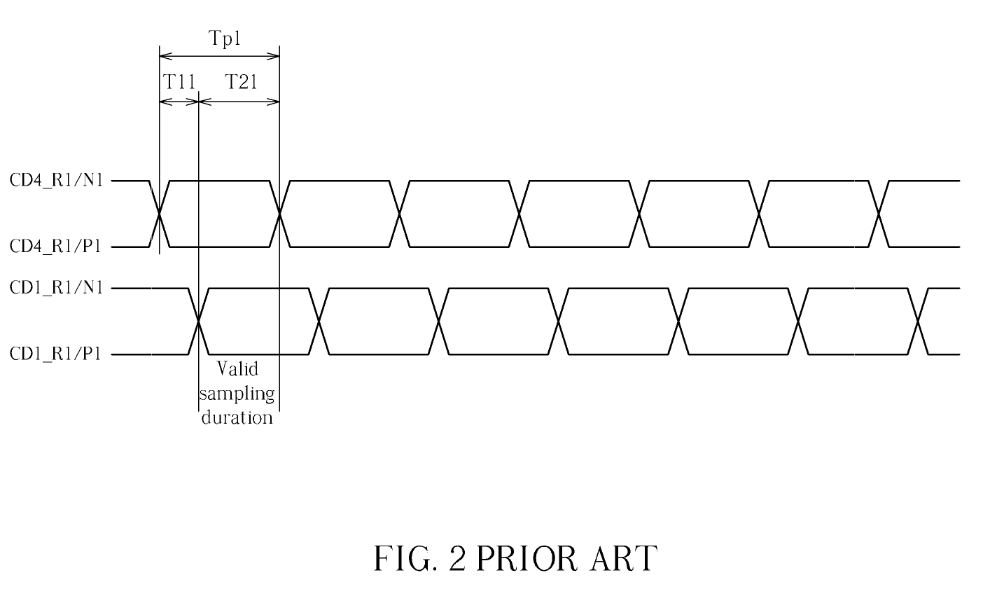

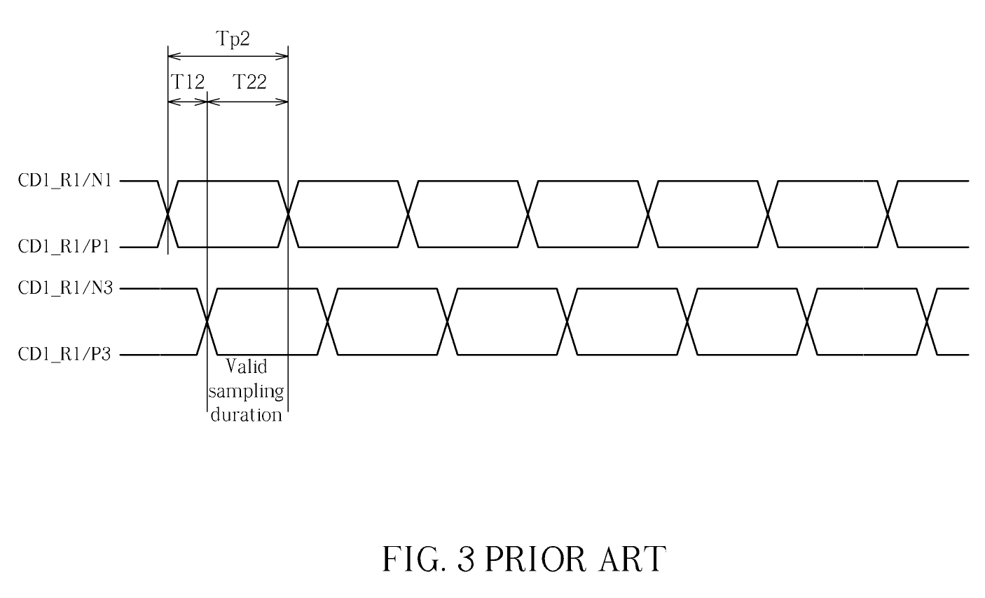

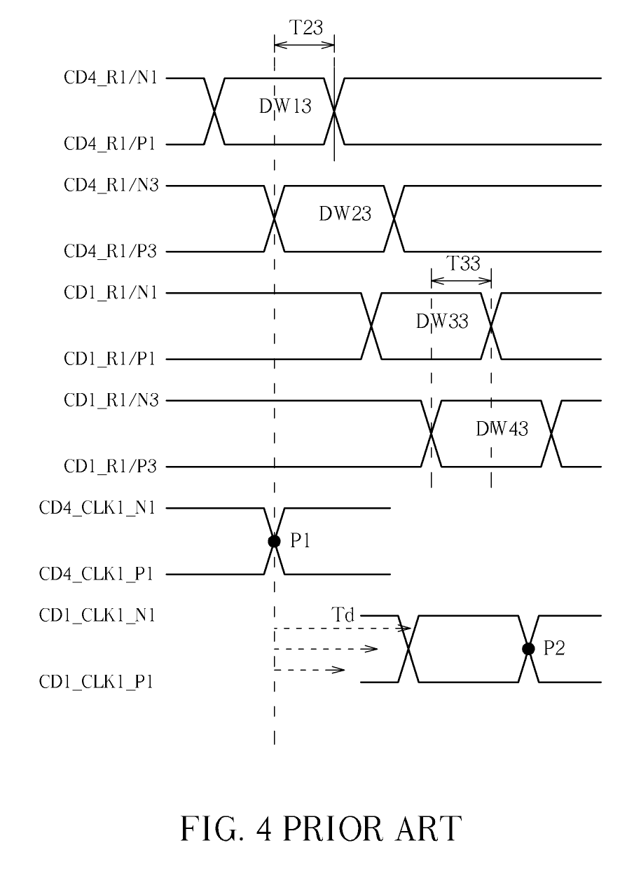

### DETAILED DESCRIPTION

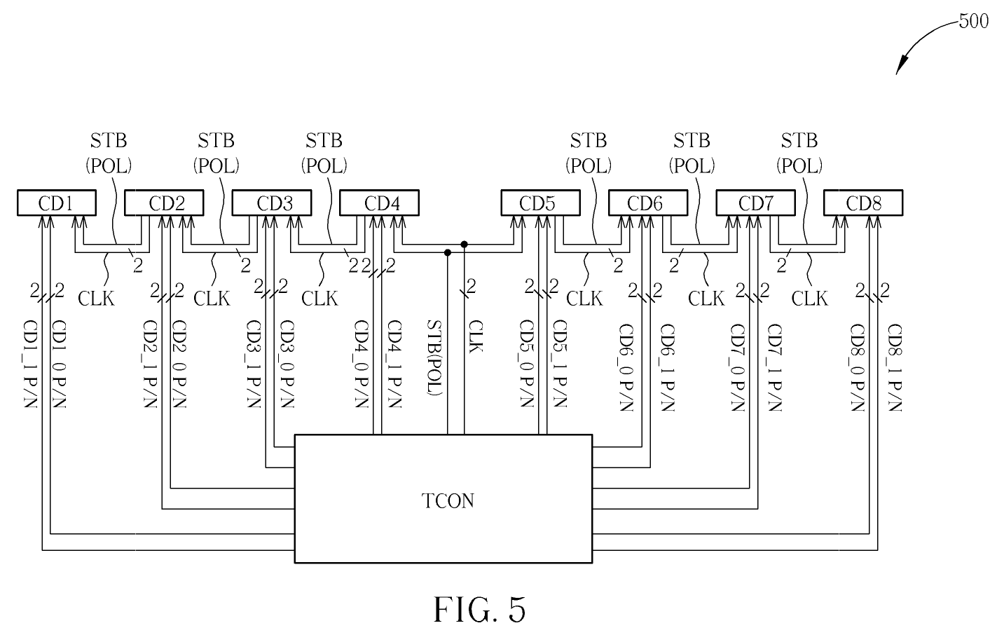

Please refer to FIG. 5, which illustrates a schematic diagram of a data transmission device 500 of a display device according to an embodiment of the present invention. The data transmission device 500 includes a timing controller TCON, source drivers CD1-CD8 and transmission line sets CD1_0P/N-CD8_0P/N and CD1_1P/N-CD8_1P/N. The timing controller TCON generates sixteen data signal pairs, every two of which corresponding to the same source driver jointly generate four voltage levels in the source driver side. The data signal pairs are embedded all in data-line differential signaling (EDDS) known as differential signals featuring multilevel current intensities, with which the source driver CD1-CD8 can determine a bit state (0 or 1) and a type of received data according to voltage levels and voltage differences of a terminal resistor. The timing controller TCON is coupled to the source drivers CD1-CD8 with the transmission line sets CD1_0P/N-CD8_0P/N and CD1_1P/N-CD8_1P/N in a dedicated channel manner. Each transmission line set CDi_P/N includes differential signaling line pairs CDi_0P/N and CDi_1P/N each responsible for one data signal pair, where i is a serial number of the source drivers from 1 to 8. The former includes signal lines CDi_0P and CDi_0N, and the latter includes signal lines CDi_1P and CDi_1N. In addition, the timing controller TCON also generates a clock signal CLK with a differential signal form of two voltage levels and the clock signal CLK is transmitted to the source drivers CD1-CD8 in a manner combining bus and cascading manners. The combined manner for the clock signal CLK is described as below. The clock signal CLK firstly is transmitted to the source drivers CD4 and CD5 via a bus. The clock signal CLK sent to the source driver CD4 passes through the internal circuit, giving the clock signal CLK a delay or not, and is then outputted to pass through the internal circuits of the source drivers CD3 and CD2, and is finally received by the source drivers CD1. The clock signal CLK passes through the source driver CD5 to the source driver CD8 in the same cascading manner.

For controls of the source drivers CD1-CD8, the timing controller TCON can generate differently-defined single-ended signals, which are transistor-to-transistor logic (TTL) or complementary metal-oxide semiconductor (CMOS) signals. In FIG. 5, the timing controller TCON is simply depicted to generate an output setup signal STB of the TTL form, which is configured for controlling the time the source drivers CD1-CD8 output analog data signals to the display panel. The timing controller TCON adopts a combination of the bus and cascading manners, similar to the manner for the clock signal CLK, for transmission of the output setup signal STB. In addition, the timing controller TCON generates a polarity signal POL for controlling voltage polarity of the analog data signals. The polarity signal POL is transmitted to the source drivers CD1-CD8 in the same way as the output setup signal STB.

With the transmission line sets CD1_0P/N-CD8_0P/N and CD1_1P/N-CD8_1P/N, the timing controller TCON can individually control the time each data signal pair arrives corresponding source driver. In other words, those skills in the art can modify the output time of each data signal pair according to line lengths of the transmission line sets CD1_0P/N-CD8_0P/N and CD1_1P/N-CD8_1P/N in order to diminish data skews. Furthermore, those skills in the art can appropriately adjust timing relationship between data signal pairs, the clock signal CLK, and the control signals, to obtain reliable valid sampling durations in the source drivers CD1-CD8, so as to diminish clock skews.

Please note that the clock signal in the present invention can be a differential or single-ended signal, and transmitted to the source drivers in the cascading, bus, or dedicated channel manner or in a manner combining any of the cascading, bus, and dedicated channel manners. The control signals, such as output setup signal STB and polarity signal POL, are all single-ended signals, and can be transmitted in any of the abovementioned manners used for the clock signal. In addition, the transmission line sets corresponding to the same source driver may include more than two differential signaling line pairs as the data signal pairs corresponding to the same source driver are adapted to generate more than four voltage levels in the source driver side.

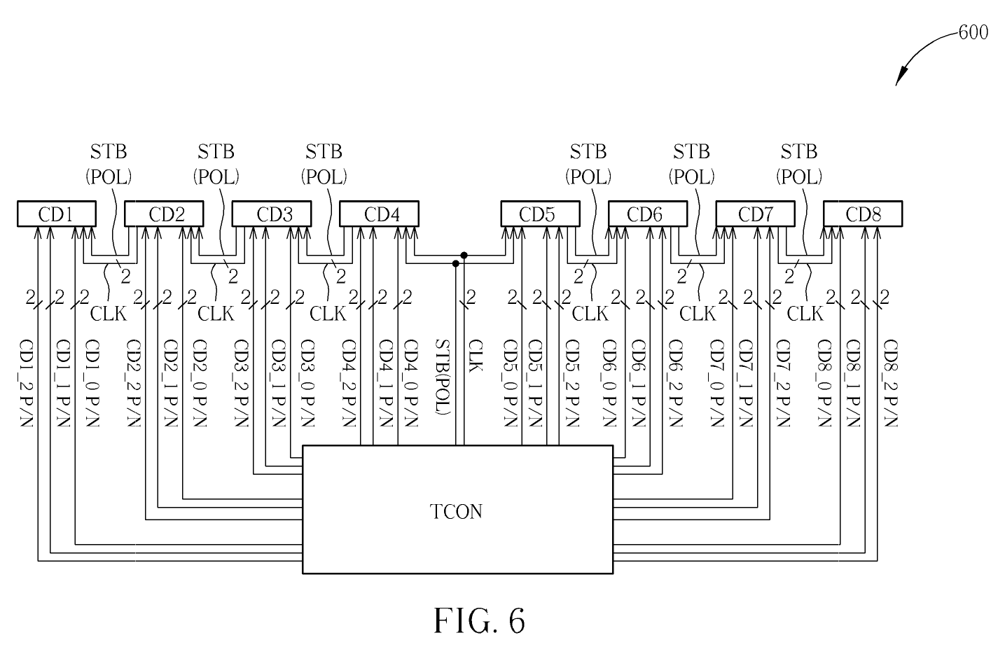

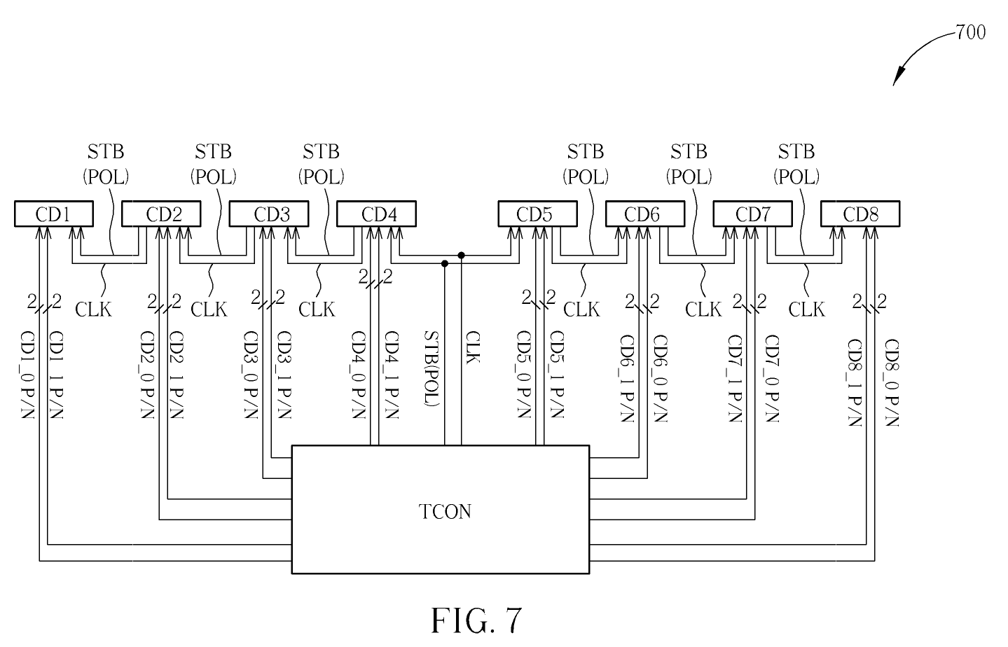

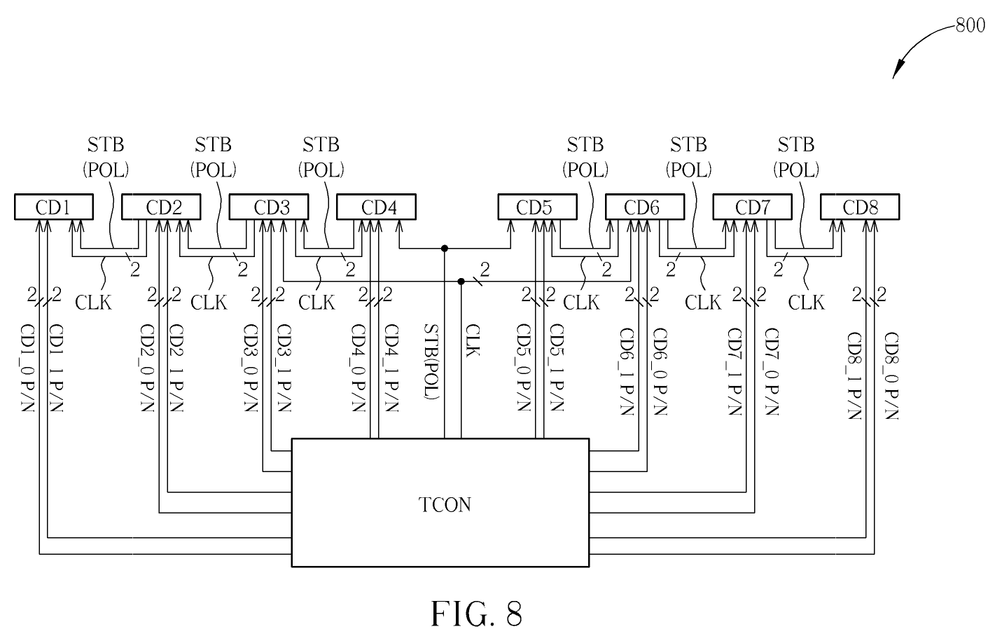

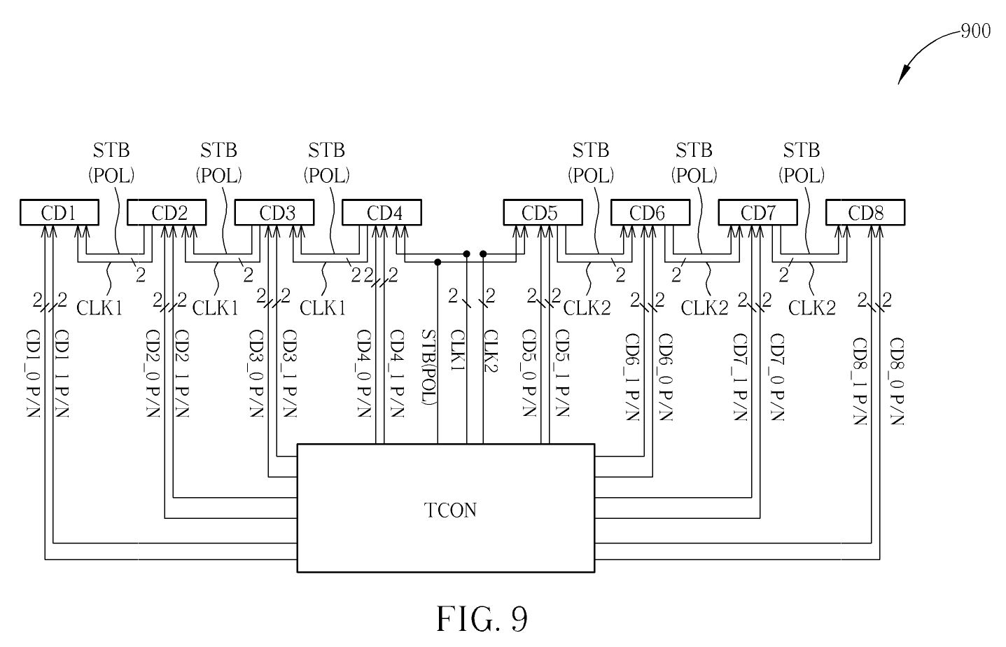

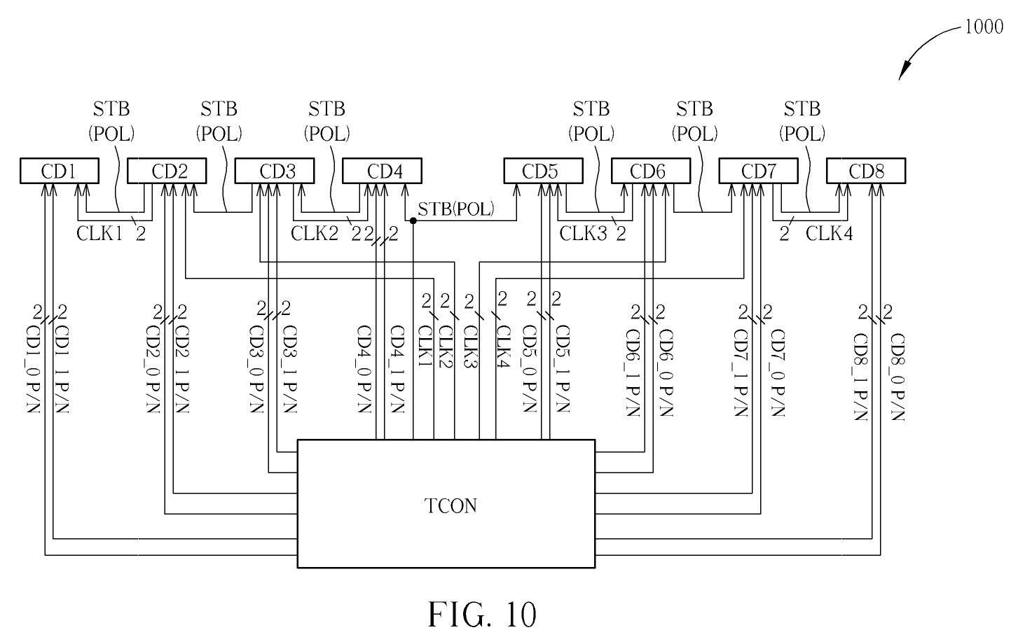

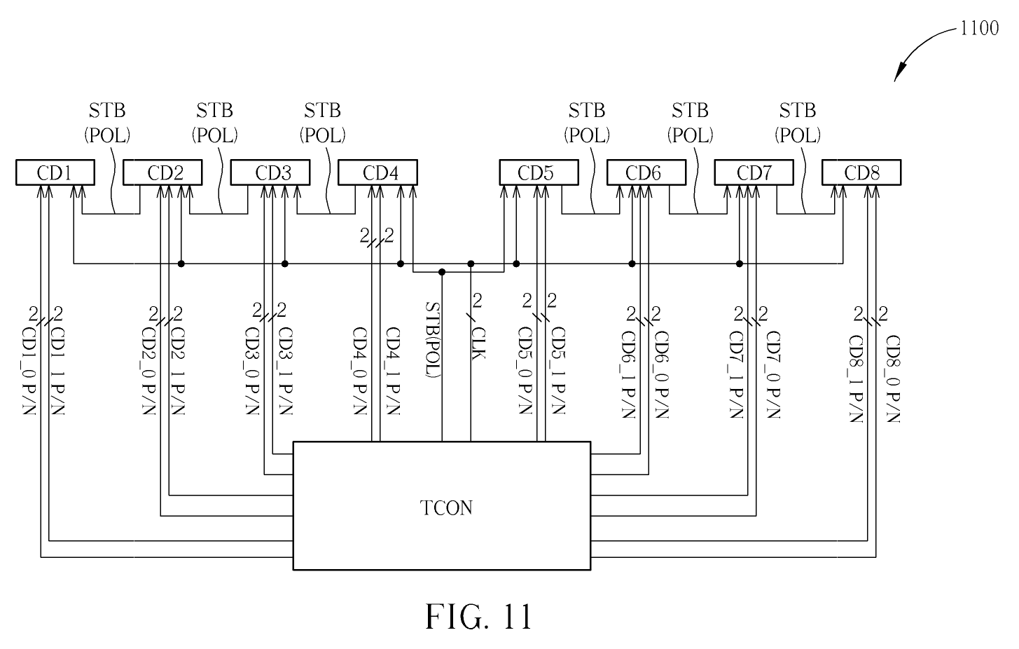

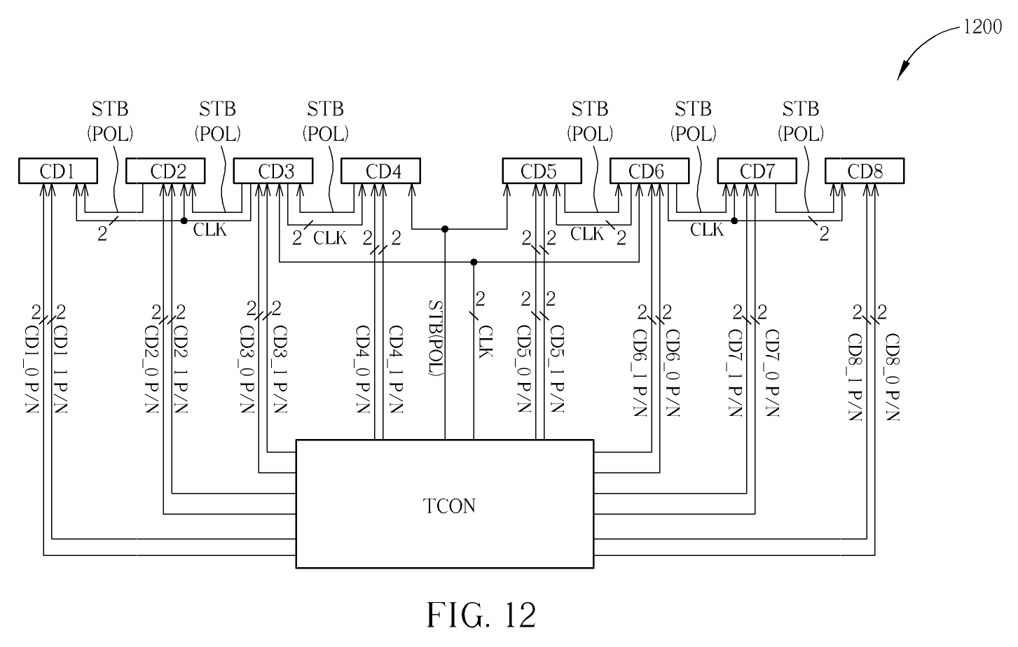

Please refer to FIGS. 6 to 12, which illustrate schematic diagrams of data transmission device 600-1 200 of a display device according to an embodiment of the present invention. The data transmission devices 600-1 200 all do modifications to partial elements of the data transmission device 500. In the data transmission device 600, the timing controller TCON generates twenty-four data signal pairs transmitted to the source drivers CD1-CD8 in the dedicated channel manner. Each the source driver accordingly receives three data signal pairs, which can generate six voltage levels. The transmission line set CDi_P/N of the data transmission device 600 includes differential signaling line pairs CDi_0P/N, CDi_1P/N, and CDi_2P/N, each transmitting a data signal pair. The differential signaling line pair CDi_0P/N includes signal lines CDi_0P and CDi_0N, and the differential signaling line pair CDi_2P/N includes signal lines CDi_2P and CDi_2N, and so on. The rest of signals and transmission thereof are the same as those in the data transmission device 500.

In the data transmission device 700, the timing controller TCON generates a clock signal CLK in single-ended form, and the clock signal CLK is transmitted in the combination of the bus and cascading manners.

In the data transmission device 800, the timing controller TCON transmits a differential clock signal CLK in the combination of the bus and cascading manners. Different to the data transmission device 500, the differential clock signal CLK is transmitted to the source drivers CD3 and CD6 via a bus. The source drivers CD3 and CD4, the source drivers CD3-CD1, the source drivers CD6 and CD5, and the source drivers CD6-CD8 form four cascading transmission groups.

In the data transmission device 900, the timing controller TCON transmits a differential clock signal in a combination of the dedicated-channel and cascading manners. First, the timing controller TCON generates clock signals CLK1 and CLK2, transmitted to the source drivers CD4 and CD5 via dedicated differential signaling pairs respectively. The source drivers CD4-CD1 further transmits the clock signal CLK1 in the cascading manner, whereas the source drivers CD5-CD8 form a cascading group to transmit the clock signal CLK2.

In the data transmission device 1000, the timing controller TCON transmits differential clock signals in a combination of the dedicated-channel and cascading manners. The timing controller TCON generates clock signals CLK1-CLK4, which are transmitted to the source drivers CD2, CD3, CD6, and CD7 via dedicated differential signaling pairs respectively. For the cascading transmission part, the source drivers CD2, CD3, CD6, and CD7 then transmit clock signals CLK1, CLK2, CLK3, and CLK4 to the source drivers CD1, CD4, CD5, and CD8, respectively.

In the data transmission device 1100, the timing controller TCON transmits a differential clock signal in the bus manner. In the data transmission device 1200, the timing controller TCON transmits a differential clock signal in a combination of the bus and cascading manners. The timing controller TCON generates and transmits a clock signal CLK to the source drivers CD3 and CD6 via a bus. The source driver CD3 transmits the clock signal CLK to the source drivers CD2 and CD4 in the cascading manner, whereas the source drivers CD1 and CD2 jointly receive the clock signal CLK via a bus. Similarly, the source driver CD6 transmits the clock signal CLK to the source drivers CD5 and CD7 in the cascading manner, and the source drivers CD7 and CD8 jointly receive the clock signal CLK via a bus.

In the data transmission devices 600-1200, the foregoing transmission manner for the clock signals are applicable for the output setup STB and the polarity signal POL as well.

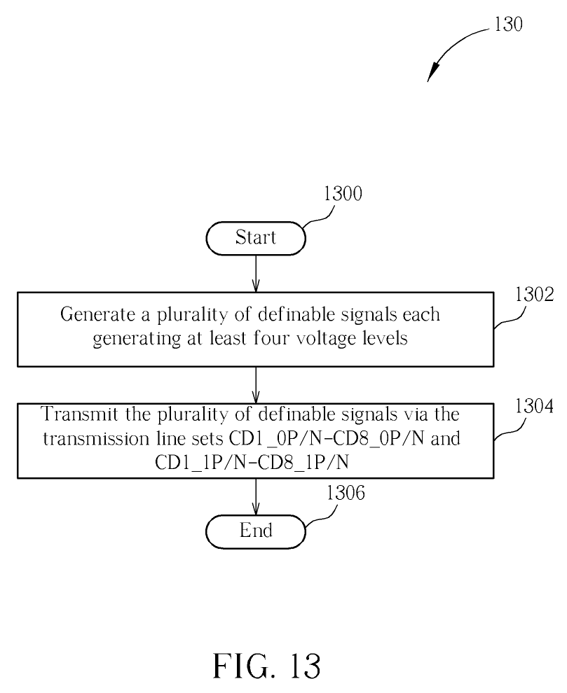

Please refer to FIG. 13, which illustrates a flowchart of a data transmission process 130 according to an embodiment of the present invention. The data transmission process 130 is applied to the data transmission devices 500-1200 and includes the following steps:

Step 1300: Start.

Step 1302: Generate a plurality of definable signals each generating at least four voltage levels.

Step 1304: Transmit the plurality of definable signals via the transmission line sets CD1_0P/N-CD8_0P/N and CD1_1P/N-CD8_1P/N.

Step 1306: End.

In the data transmission process 130, the definable signals can be defined as data signal pairs, preferably in EDDS form. When each data signal pair is configured for generating four voltage levels, each transmission line set includes two differential signaling line pairs, each transferring a signal pair. When each data signal pair is configured for generating six voltage levels, each transmission line set includes three differential signaling line pairs. In the data transmission process 130, a differential or single-ended clock signal is further generated and transmitted in the cascading, bus, or dedicated channel manner or in a manner combining any of the cascading, bus, and dedicated channel manners. In addition, control signals are generated in single-ended form and transmitted in any manners used for the clock signal. Therefore, with the transmission line sets CD1_0P/N-CD8_0P/N, CD1_1P/N-CD8_1P/N transmitting the data signal pairs independently, the data transmission process 130 can control the time the data signal pairs arrive corresponding source drivers. According to system requirements, those skills in the art can appropriately build up optimum timing relationships between data signal pair and data signal pair, and the data signal pairs and the clock and control signals, to diminish clock and data skews.

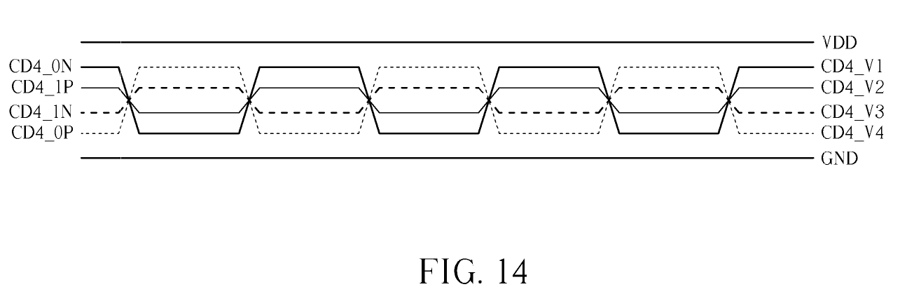

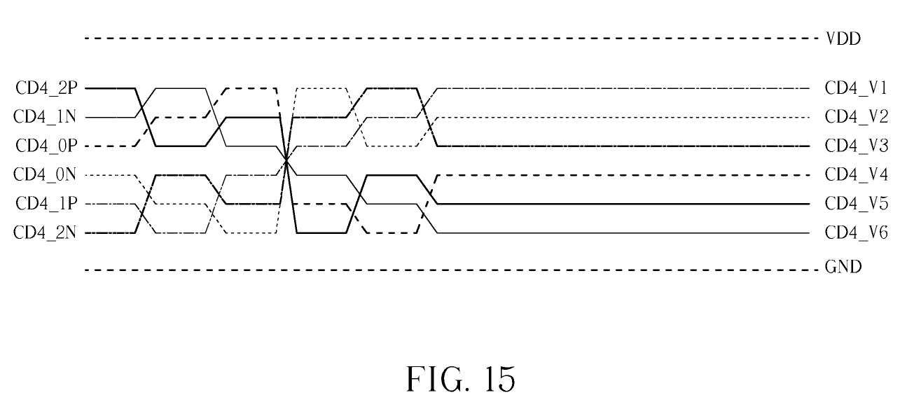

Please refer to FIG. 14, which illustrates a waveform schematic diagram of the data signal pairs of the data transmission device 500 according to FIG. 5. In FIG. 14, a voltage VDD is power supplying voltage, whereas a voltage GND is system grounding voltage. The differential signaling line pairs CD4_0P/N and CD4_1P/N are responsible for a signal pair for the source driver CD4 respectively. Levels CD4_V1-CD4_V4 are all possible signal levels, and each signal on a differential signaling line (ex. CD4_0P) changes its signal level clock by clock. Please refer to FIG. 15, which illustrates a waveform schematic diagram of the data signal pairs of the data transmission device 600 according to FIG. 6. In FIG. 15, the differential signaling line pairs CD4_0P/N, CD4_1P/N, and CD4_2P/N are responsible for a signal pair for the source driver CD4 respectively, and levels CD4_V1-CD4_V6 are all possible signal levels.

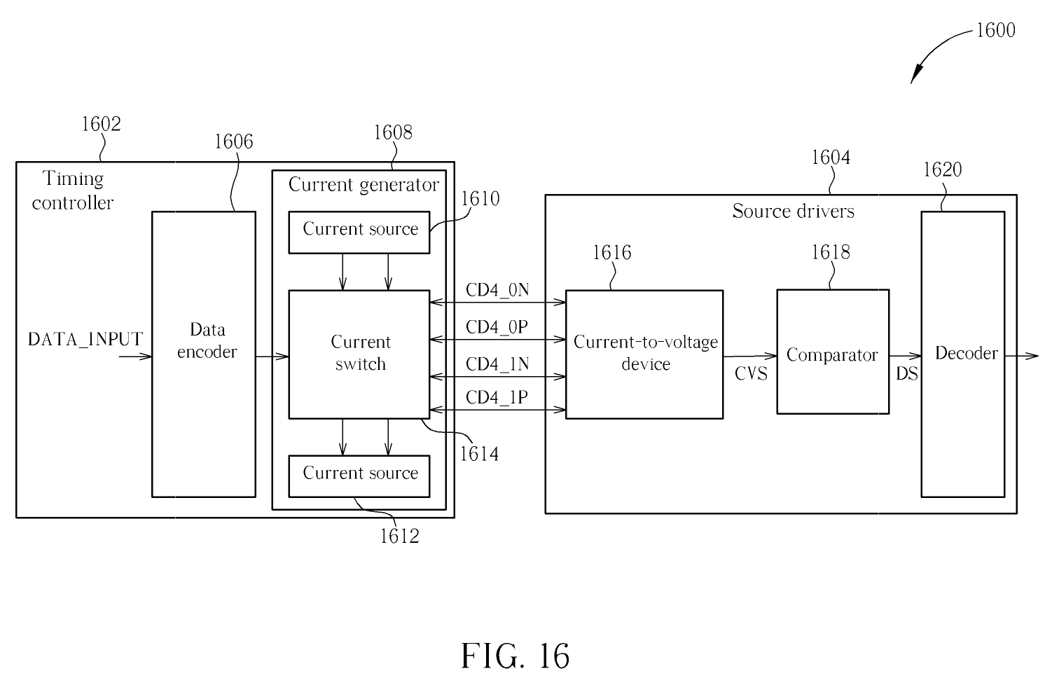

Pleaser refer to FIG. 16, which illustrates a schematic diagram of a data transmission device 1600 employing four voltage levels shown in FIG. 14 according to an embodiment of the present invention. The data transmission device 1600 includes a timing controller 1602, a source drivers 1604, and differential signaling lines CD4_0N, CD4_0P, CD4_1N and CD4_1P. The timing controller 1602 includes a data encoder 1606 and a current generator 1608 including current sources 1610 and 1612 and a current switch 1614. The data encoder 1606 encodes data DATA_INPUT, which the timing controller 1602 attempts to transmit to the source drivers 1604, into switching control signals for controlling the current switch 1614 to combine the current directions and intensities outputted by the current sources 1610 and 1612. The differential signaling lines CD4_0N, CD4_0P, CD4_1N and CD4_1P are transmission lines between the timing controller 1602 and the source drivers 1604, and used for outputting the current signals from the current switch 1614. The source driver 1604 includes a current-to-voltage device 1616, a comparator 1618 and a decoder 1620. The current-to-voltage device 1616 converts the received current signals into a voltage signal CVS, and further the comparator 1618 converts the voltage signal CVS into a digital signal DS. The decoder 1620 decodes the digital signal DS for the transmission of timing controller 1602.

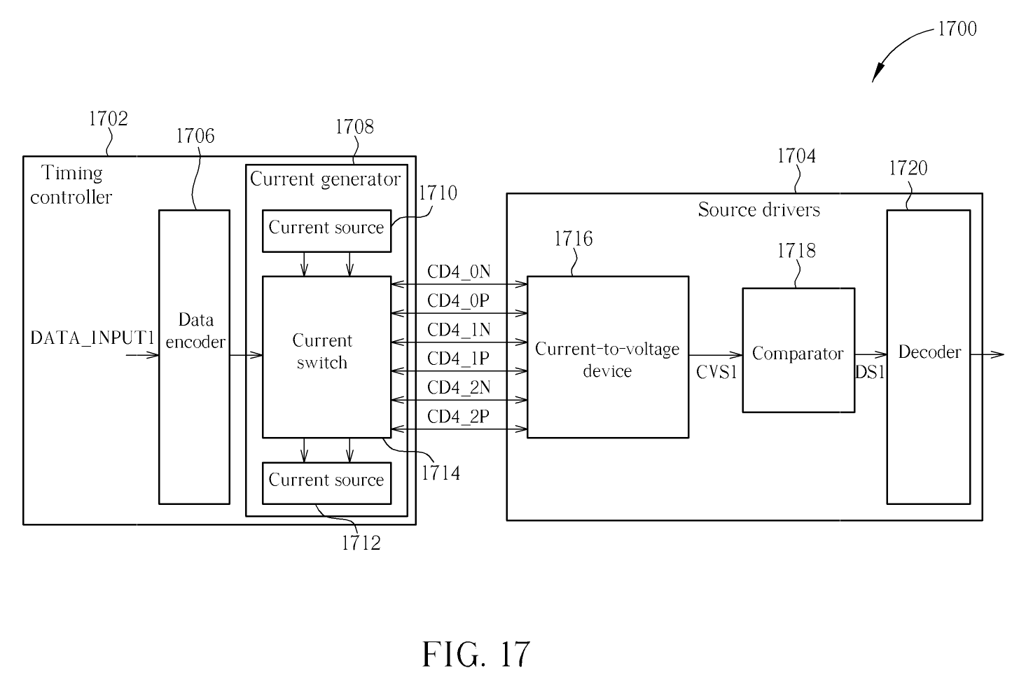

Pleaser refer to FIG. 17, which illustrates a schematic diagram of a data transmission device 1700 employing six voltage levels shown in FIG. 15 according to an embodiment of the present invention. The data transmission device 1700 includes a timing controller 1702, a source drivers 1704, and differential signaling lines CD4_0N, CD4_0P, CD4_1N. CD4_1P, CD4_2N and CD4_2P. The timing controller 1702 includes a data encoder 1706 and a current generator 1708 including current sources 1710 and 1712 and a current switch 1714. The data encoder 1706 encodes data DATA_INPUT1, which the timing controller 1702 attempts to transmit to the source drivers 1704, into switching control signals for controlling the current switch 1714 to combine the current directions and intensities outputted by the current sources 1710 and 1712. The differential signaling lines CD4_0N, CD4_0P, CD4_1N, CD4_1P, CD4_2N and CD4_2P are used for outputting the current signals from the current switch 1714. The source driver 1704 includes a current-to-voltage device 1716, a comparator 1718 and a decoder 1720. The current-to-voltage device 1716 converts the received current signals into a voltage signal CVS1, and further the comparator 1718 converts the voltage signal CVS1 into a digital signal DS1. The decoder 1720 decodes the digital signal DS1 for the transmission of timing controller 1702.

In summary, the embodiments of the present invention utilize the dedicated channel manner to transmit the data signals featuring at least four voltage levels, and further use any or a combined manner of the bus, cascading, and dedicated channel manners to transmit the clock and control signals. Compared to the prior art, the embodiments of the present invention diminishes data and clock skews with a less number of interfacing signals, a lower transmission rate, a low level VLSI process and lower cost. Thus, the sampling error rate in the source drivers is reduced.

Those skilled in the art will readily observe that numerous modifications and alterations of the device and method may be made while retaining the teachings of the invention.

What is claimed is:

1. A data transmission device for a display device, the data transmission device comprising:
a timing controller for generating a plurality of definable signals each generating at least four voltage levels;
a plurality of source drivers for receiving the plurality of definable signals; and
a plurality of transmission line sets coupled between the timing controller and the plurality of source drivers, for transmitting the plurality of definable signals.

2. The data transmission device of claim 1, wherein the plurality of definable signals is differential signals.

3. The data transmission device of claim 1, wherein the plurality of definable signals are defined as data signals, and the timing controller transmits the data signals to the plurality of source drivers via the plurality of transmission line sets arranged to dedicated channel architecture.

4. The data transmission device of claim 1, wherein the timing controller further generates a clock signal with differential signal form and transmits the clock signal to the plurality of source drivers in a cascading, bus, or dedicated channel manner or in a manner combining any of the cascading, bus, and dedicated channel manners.

5. The data transmission device of claim 1, wherein each of the plurality of definable signals generates four voltage levels, and each of the plurality of transmission line sets comprises two differential signaling line pairs.

6. The data transmission device of claim 1, wherein each of the plurality of definable signals generates six voltage levels, and each of the plurality of transmission line sets comprises three differential signaling line pairs.

7. The data transmission device of claim 1, wherein the timing controller further generates at least a definable single-ended signal defined as a clock signal, an output setup signal, or a polarity signal.

8. The data transmission device of claim 7, wherein the at least a definable single is a transistor-to-transistor logic (TTL) signal.

9. The data transmission device of claim 7, wherein the at least a definable single is transmitted between the timing controller and the plurality of source drivers in a cascading, bus, or dedicated channel manner or in a manner combining any of the cascading, bus, and dedicated channel manners.

10. A data transmission method for a display device, the data transmission method comprising:
generating a plurality of definable signals each generating at least four voltage levels; and
transmitting the plurality of definable signals via a plurality of transmission line sets.

11. The data transmission method of claim 10, wherein the plurality of definable signals are differential signals.

12. The data transmission method of claim 10 further comprising:
defining the plurality of definable signals as data signals; and
transmitting the data signals via the plurality of transmission line sets arranged to dedicated channel architecture.

13. The data transmission method of claim 10 further comprising:
generating a clock signal with differential signal form; and
transmitting the clock signal in a cascading, bus, or dedicated channel manner or in a manner combining any of the cascading, bus, and dedicated channel manners.

14. The data transmission method of claim 10, wherein each of the plurality of definable signals generates four voltage levels, and each of the plurality of transmission line sets comprises two differential signaling line pairs.

15. The data transmission method of claim 10, wherein each of the plurality of definable signals generates six voltage levels, and each of the plurality of transmission line sets comprises three differential signaling line pairs.

16. The data transmission method of claim 10 further comprising generating at least a definable single-ended signal defined as a clock signal, an output setup signal, or a polarity signal.

17. The data transmission method of claim 16, wherein the at least a definable single is a transistor-to-transistor logic (TTL) signal.

18. The data transmission method of claim 16 further comprising transmitting the least a definable single in a cascading, bus, or dedicated channel manner or in a manner combining any of the cascading, bus, and dedicated channel manners.

19. A data transmission device for a display device, the data transmission device comprising:
a timing controller for generating a plurality of differential signals each generating at least four voltage levels;
a plurality of source drivers for receiving the plurality of differential signals; and
a plurality of transmission line sets coupled between the timing controller and the plurality of source drivers in a dedicated channel manner, for transmitting the plurality of differential signals.

20. The data transmission device of claim 19, wherein each of the plurality of differential signals generates four voltage levels, and each of the plurality of transmission line sets comprises two differential signaling line pairs.

21. The data transmission device of claim 19, wherein each of the plurality of differential signals generates six voltage levels, and each of the plurality of transmission line sets comprises three differential signaling line pairs.

22. A data transmission method for a display device comprising a timing controller and a plurality of source drivers, the data transmission method comprising:
generating a plurality of differential signals each generating at least four voltage levels; and
transmitting the plurality of differential signals between the timing controller and the plurality of source drivers via a plurality of transmission line sets in a dedicated channel manner.

23. The data transmission method of claim 22, wherein each of the plurality of differential signals generates four voltage levels, and each of the plurality of transmission line sets comprises two differential signaling line pairs.

24. The data transmission method of claim 22, wherein each of the plurality of differential signals generates six voltage levels, and each of the plurality of transmission line sets comprises three differential signaling line pairs.
